(19) United States
(12) Patent Application Publication
(10) Pub. No.: US 2008/0183482 A1
(43) Pub. Date: Jul. 31, 2008

(54) LOGISTIC PKI SERVICE SYSTEM, MOBILE TERMINAL, LOGISTIC PKI SERVICE METHOD USED FOR THE SAME, AND RECORDING MEDIUM IN WHICH CORRESPONDING PROGRAM IS RECORDED

(75) Inventors: Toru KATAYAMA, Tokyo (JP); Yoshinori YOSHIDA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/967,831

(22) Filed: Dec. 31, 2007

Related U.S. Application Data
(62) Division of application No. 10/348,914, filed on Jan. 23, 2003, now abandoned.

(30) Foreign Application Priority Data
Jan. 30, 2002 (JP) 020841/2002

(51) Int. Cl. G06Q 99/00

(52) U.S. Cl. 705/1

(57) ABSTRACT

The present invention provides a logistic PKI service system that improves reliability and security of its distribution portion. An article displayed on a shop terminal is purchased from a user's mobile terminal via a network. Then, a shop terminal receives distribution label data from a PKI. The user's mobile terminal receives authentication information transmitted by the PKI. The shop terminal generates a distribution label on the basis of the distribution label data from the PKI. Then, the shop terminal attaches the distribution label to the article and then requests a distributor to deliver the article. After the distributor delivers the article to a user, the user's mobile terminal reads information from the distribution label attached to the article. The user's mobile terminal then carries out information on the basis of the information from the distribution label and the authentication information from the PKI.

### BACKGROUND OF THE INVENTION

1. Field of the Invention

The present invention relates to a logistic PKI service system, a mobile apparatus, a logistic PKI service method used for the same, and a recording medium in which a corresponding program is recorded, and in particular, to PKI (public Key Infrastructure) service associated with distribution and represented by electronic commerce.

2. Description of the Prior Art

In recent years, because of the common use of the Internet, service represented by electronic commerce, that is, service associated with distribution and represented by electronic commerce has been popularized. This service mainly electronically supports functions of ordering goods and settling charges.

Furthermore, mobile EC (Electronic Commerce) has also become popular which uses mobile terminals such as cellular phones and PDAs (personal Digital Assistants). For electronic commerce on the Internet, there are a large number of systems (services) that provides functions on the network.

However, with the above described conventional system that provides functions on the network, even if an article is purchased on the Internet, it is actually delivered by using a distribution system. Accordingly, the article must be visually checked and a receipt sealed to achieve operations of determining whether or not the delivered article has been sent by a valid sender or whether or not the actually ordered article has been sent. This may cause troubles during delivery.

In this case, the troubles during delivery include failures to ensure reliability and security in a distribution portion of the system such as home delivery service, general mail service (registered mail and so forth), main-order selling, or electronic commerce, for example, the incorrect delivery of an article, the unknown sender of the article, and the inability to check the requested article, and so forth.

Consequently, the conventional electronic commerce does not provide any functions of electronically supporting the above described operations associated with distribution. Therefore, the conventional electronic commerce is not so popular as the conventional mail-order selling.

### SUMMARY OF THE INVENTION

It is thus an object of the present invention to provide a logistic PKI service system, a mobile terminal, and a logistic PKI service method used for the same which can solve the above problems and improve reliability and security in distributions.

A logistic PKI service system according to the present invention includes:

a terminal apparatus which requests an authentication bureau to provide label data indicative of information on a delivered article before delivery and generates a label to be attached to the delivered article on the basis of the transmitted label data;

the authentication bureau which responds to the request from the terminal apparatus to issue the label data and authentication information on the delivered article; and

a mobile terminal which carries out authentication on the basis of information read from the label attached to the delivered article that has been delivered and the authentication information from the authentication bureau.

A mobile terminal according to the present invention comprises means for carrying out authentication on the basis of information read from a label attached to a delivered article as well as authentication information on the delivered article which is transmitted by an authentication bureau.

A logistic PKI service method according to the present invention includes the steps of:

in a terminal apparatus, requesting an authentication bureau to provide label data indicative of information on a delivered article before delivery and generates a label to be attached to the delivered article on the basis of the label data transmitted in response to the request;

in the authentication bureau, responding to the request from the terminal apparatus to issue the label data and authentication information on the delivered article; and

in a mobile terminal, carrying out authentication on the basis of information read from the label attached to the delivered article that has been delivered and the authentication information from the authentication bureau.

A recording medium according to the present invention has a program recorded therein to execute the steps of:

in a terminal apparatus, requesting an authentication bureau to provide label data indicative of information on a delivered article before delivery and generates a label to be attached to the delivered article on the basis of the label data transmitted in response to the request;

in the authentication bureau, responding to the request from the terminal apparatus to issue the label data and authentication information on the delivered article; and

in a mobile terminal, carrying out authentication on the basis of information read from the label attached to the delivered article that has been delivered and the authentication information from the authentication bureau.

That is, with the logistic PKI (Public Key Infrastructure) service system of the present invention, a terminal apparatus of a shop or a post office, and so forth, requests an authentication bureau to provide label data indicative of information on a delivered article before delivery. The authentication bureau responds to the request from the terminal apparatus to issue the label data and authentication information on the delivered article. The terminal apparatus of a shop or a post office, and so forth, generates a label on the basis of the label data from the authentication bureau and attach it to the delivered article. A user's mobile terminal authenticates the user, the delivered article, the shop or post office, and so forth on the basis of information read from the label attached to the delivered article that has been delivered and the authentication information from the authentication bureau.

With this configuration, a logistic PKI service of the present invention can use electronic signatures including a certificate for a public key to prevent the incorrect delivery and to check the sender and the request article (the case of mail-order selling). This improves reliability and security in the distribution portion of home delivery service for gifts, general post service (registered mail and the like), mail-order selling, or electronic commerce (EC: Electronic Commerce).

### BRIEF DESCRIPTION OF THE DRAWINGS

FIG. 1 is a block diagram showing a configuration of a logistic PKI service system according to a first embodiment of the present invention;

FIG. 2 is a block diagram showing a configuration of a user mobile terminal in FIG. 1;

FIG. 3 is a block diagram showing a configuration of a PKI in FIG. 1;

FIG. 4 is a block diagram showing a configuration of a shop terminal in FIG. 1;

FIG. 5 is a sequence chart showing operations performed by the logistic PKI service system according to the first embodiment of the present invention;

FIG. 6 is a block diagram showing a configuration of a logistic PKI service system according to a second embodiment of the present invention;

FIG. 7 is a sequence chart showing operations performed by the logistic PKI service system according to the second embodiment of the present invention;

FIG. 8 is a block diagram showing a configuration of a logistic PKI service system according to a third embodiment of the present invention;

FIG. 9 is a block diagram showing a configuration of a logistic PKI service system according to a fourth embodiment of the present invention;

FIG. 10 is a sequence chart showing operations performed by the logistic PKI service system according to the fourth embodiment of the present invention;

FIG. 11 is a block diagram showing a configuration of a logistic PKI service system according to a fifth embodiment of the present invention;

FIG. 12 is a block diagram showing a configuration of a mobile terminal in FIG. 11;

FIG. 13 is a block diagram showing a configuration of a PKI in FIG. 11;

FIG. 14 is a block diagram showing a configuration of a post office terminal in FIG. 11; and

FIG. 15 is a sequence chart showing operations performed by the logistic PKI service system according to the fifth embodiment of the present invention.

### DETAILED DESCRIPTION OF THE PREFERRED EMBODIMENTS

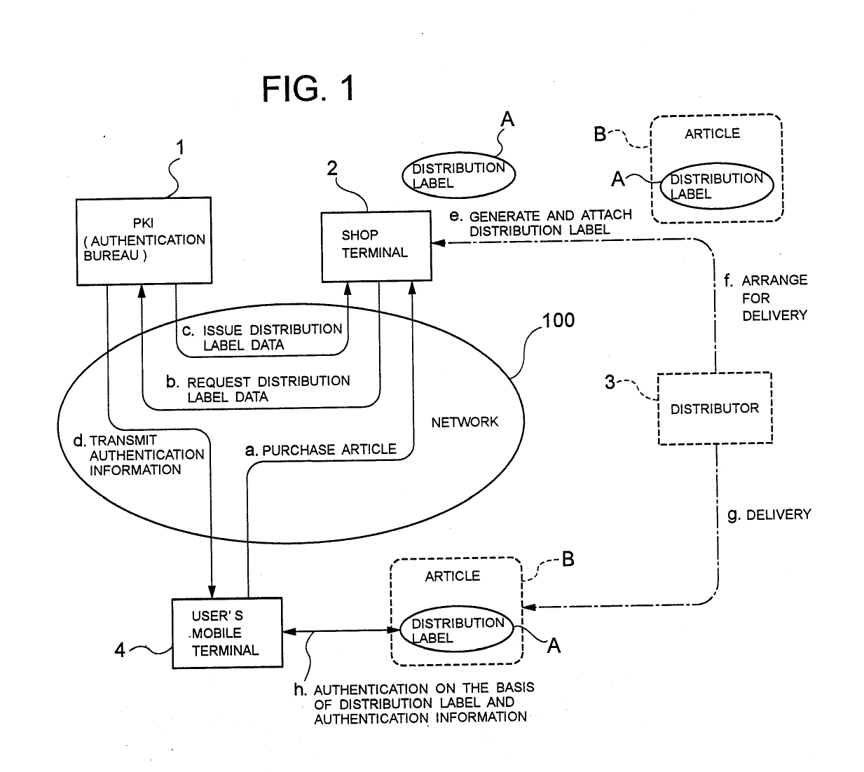

Now, embodiments of the present invention will be described with reference to the drawings. FIG. 1 is a block diagram showing a configuration of a logistic PKI service system according to a first embodiment of the present invention. In FIG. 1, the logistic PKI service system according to the first embodiment of the present invention is composed of a PKI (Public Key Infrastructure) (authentication bureau) 1, a shop terminal 2, and a user's mobile terminal 4. A distribution portion of this system includes a distributor 3 who carries out delivery of an article from the shop to the user.

Existing service associated with distribution includes the purchase and home delivery of an article in the general shops and general mail service (registered mail and so forth) such as electronic commerce (EC) (including mobile EC), mail-order selling, a gift and so forth. In the present embodiment, the mobile EC will be described.

The mobile EC generally includes a “remote environment” in which transactions are carried out on a network and a “local environment” in which transactions are actually carried out at shops. In the present embodiment there is shown the logistic PKI service system in the “remote environment”.

In general, in the “remote environment” for the mobile EC, most of the transactions are carried out through the network as described above. For example, this corresponds to purchases based on online shopping.

The present embodiment provides an authentication service associated with distribution for a sale for the mobile EC, that is, a logistic PKI service. The logistic PKI service solves the problems occurring in the conventional distribution, that is, the lack of certification that allows it to be confirmed that goods to be delivered or mailed, the requester and delivery source are correct. This significantly improves reliability, security, and clients' satisfaction. Further, the logistic PKI service is relatively easily applicable to the existing distribution systems and can thus be introduced easily.

This logistic PKI service relates to distribution in transactions which have not been solved by the conventional electronic commerce service. Accordingly, clients' satisfaction is significantly improved to reliably expand the electronic commerce market.

In the logistic PKI service for the mobile EC, when an article B purchased on a network 100 is delivered, the information issued by an authentication bureau 1 and related to the traded article B is attached as a distribution label A. The user receives the article B from a distributor 3. Then, the user's mobile terminal 4 can read from the distribution label A an electronic signature containing a certificate for a public key and which electronically certifies information indicating where the article B has been originated, who has ordered it, what it is, and so forth. The user's mobile terminal 4 can then electronically check the signature.

The above described service model is of a so-called B2C (Business to Consumer) type based on the assumption that an article is purchased on the network 100. In this model, the user is a receiver of the article, the sender of the article is a shop, and the distributor is a home delivery service company. Other possible models are of a B2C type that involves two types of users, that is, an orderer and a receiver as in the case with a gift, and so forth and a C2C (Consumer to Consumer) type for general mail service, and so forth in which no shops, and so forth are present.

In any of these models, a secure distribution system can be provided by utilizing the logistic PKI service under the user's mobile terminal 4, the PKI (authentication bureau) 1, and the distributor 3. Substantially the same model is applicable to the existing mail-order selling.

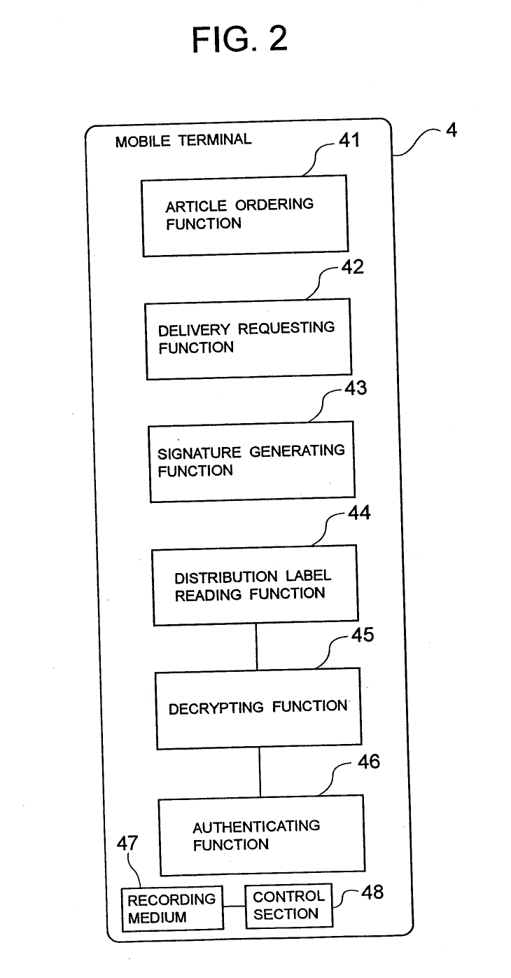

FIG. 2 is a block diagram showing a configuration of the user's mobile terminal 4 in FIG. 1. In FIG. 2, the user's mobile terminal 4 includes an article ordering function 41 for ordering the article B on the network 100, a delivery requesting function 42 for requesting delivery of the article B purchased on the network 100, a signature generating function 43 for generating an electronic signature, a distribution label reading function 44 for reading the distribution label A, a decrypting function 45 for decrypting information read from the distribution label A, an authenticating function 46 for carrying out authentication on the basis of the decrypted information from the distribution label A, a recording medium 47 in which a program for the PKI service is recorded, and a control section 48 that controls these functions according to this program.

The following other possible functions of the user's mobile terminal 4 are well known: a telephone function of a cellular phone and a data processing function of a PDA (Personal Digital Assistants). Thus, description of the corresponding configurations and operations is omitted. Further, the article ordering function 41 and the delivery requesting function 42 may have a function of transmitting information required to generate the distribution label A.

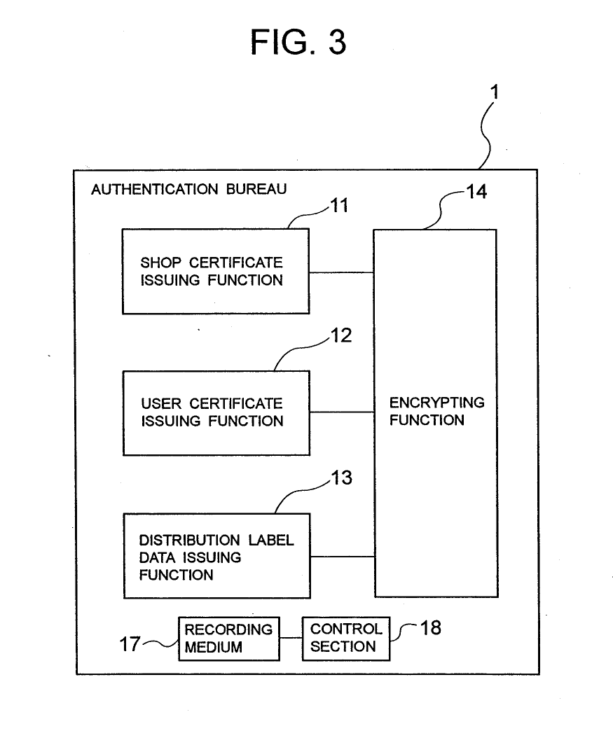

FIG. 3 is a block diagram showing a configuration of the PKI 1 in FIG. 1. In FIG. 3, the PKI 1 includes a shop certificate issuing function 11 of issuing an electronic signature containing a certificate for a public key of a shop and so forth, a user certificate issuing function 12 of issuing an electronic signature containing a certificate for a user's public key and so forth, a distribution label data issuing function 13 of issuing distribution label data on the basis of the electronic signatures issued by the shop certificate issuing function 11 and the user certificate issuing function 12 as well as article information from a shop terminal 2, an encrypting function 14 of encrypting the electronic signatures issued by the shop certificate issuing function 11 and the user certificate issuing function 12 as well as the distribution label data issued by the distribution label data issuing function 13, a recording medium 17 in which a program for the PKI service is recorded, and a control section 18 that controls these functions according to this program.

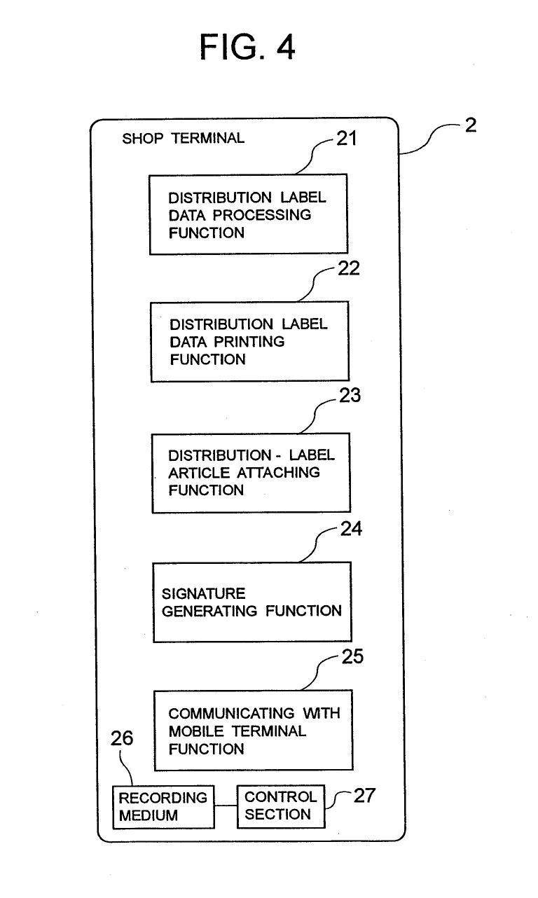

FIG. 4 is a block diagram showing a configuration of the shop terminal 2. In FIG. 4, the shop terminal 2 includes a distribution label processing apparatus composed of a distribution label data processing function 21 of requesting the PKI 1 to issue distribution label data and processing distribution label data from the PKI 1, a distribution label data printing function 22 of printing the distribution label data processed by the distribution label data processing function 21, and a distribution-label article attaching function 23 of attaching the distribution label A printed by the distribution label data printing function 22, to the article B; a signature generating function 24 of generating an electronic signature; a communicating with mobile terminal function 25 of communicating with the user's mobile terminal 4; a recording medium 26 in which a program for the PKI service is recorded; and a control section 27 that controls these functions according to this program.

The distribution label data processing function 21 processes distribution label data sent by the PKI 1 via the network 100 as digital data. The distribution label data printing function 22 prints the distribution label data processed by the distribution label data processing function 21, as the distribution label A. The distribution-label article attaching function 23 attaches the distribution label A printed by the distribution label data printing function 22, to the article B.

If the distribution label processing apparatus is placed at the shop, when a general home delivery service company is employed as a distributor for the shop, then as many distribution label processing apparatuses as delivery service reception desks are installed. Alternatively, the distribution label processing apparatus can be installed at the distributor 3.

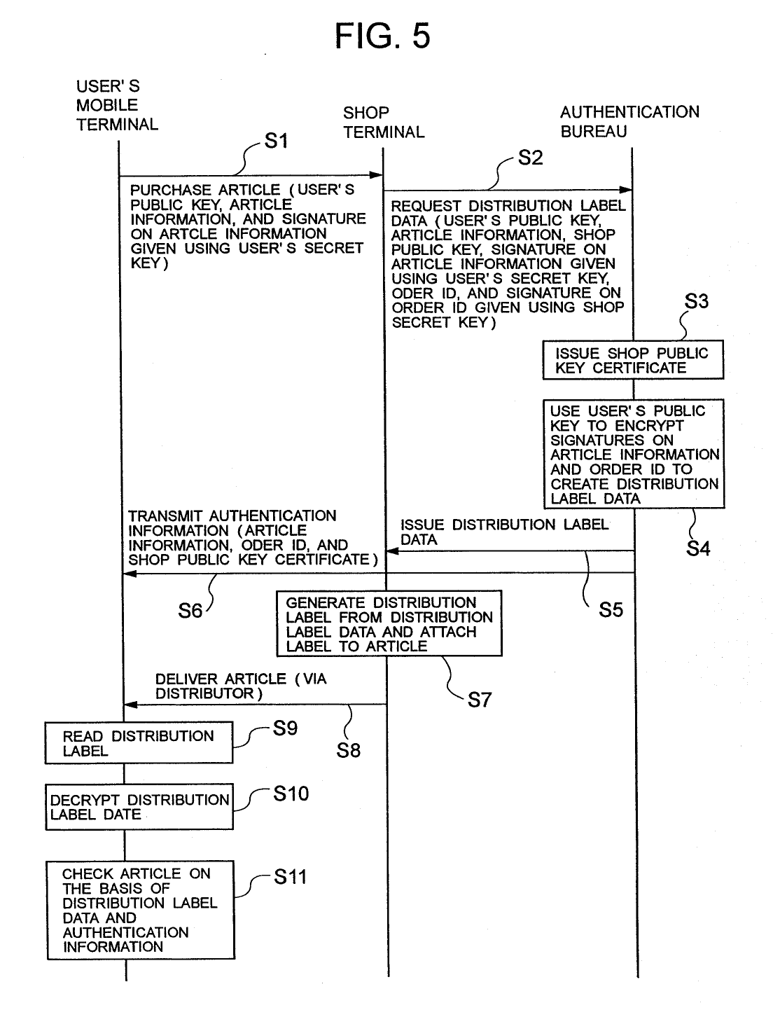

FIG. 5 is a sequence chart showing operations performed by a logistic PKI service system according to a first embodiment of the present invention. With reference to FIGS. 1 to 5, description will be given of the operations of the logistic PKI service system according to the first embodiment of the present invention. In the description below, it is assumed that the user and the shop each have a secret key and that the PKI 1 issues, as electronic signatures, public key certificates that authenticate public keys for these secret keys.

First, the user requests the purchase or delivery of the article B displayed on the shop terminal 2, through the article ordering function 41 or delivery requesting function 42 of the mobile terminal 4 via the network 100 (a in FIG. 1; step S1 in FIG. 5). The shop terminal 2 uses the distribution label data processing function 21 to request the PKI 1 to issue distribution label data on the basis of information (the user's public key, article information, and a signature on the article information given using the user's secret key) input from the user's mobile terminal 4 (b in FIG. 1; step S2 in FIG. 5).

In response to the request for issuance of distribution label data, the PKI 1 uses the shop certificate issuing function 11 to issue a public key certificate for the shop on the basis of the information (the user's public key, the article information, the public key for the shop, the signature on the article information given using the user's secret key, an order ID, and a signature on the order ID given using the secret key of the shop) input from the shop terminal 2 (step S3 in FIG. 5). The PKI 1 then uses the distribution label data issuing function 13 to encrypt the signatures on the article information and order ID on the basis of the user's public key. Thus, distribution label data is created (step S4 in FIG. 5).

The PKI 1 transmits the created distribution label data to the shop terminal 2 (c in FIG. 1; step S5 in FIG. 5). The PKI 1 then uses the encrypting function 14 to encrypt the above information (the article information, the order ID, and the public key certificate for the shop) on the basis of the user's public key to obtain authentication information. The PKI 1 then transmits the authentication information to the user's mobile terminal 4 using an electronic mail and so forth (d in FIG. 1; step S6 in FIG. 5).

Upon receiving the distribution label data issued by the PKI 1, the shop terminal 2 generates a distribution label A on the basis of the distribution label data from the PKI 1. The shop terminal 2 then attaches the distribution label A to the article B (e in FIG. 1; step S7 in FIG. 5) and then requests the distributor 3 to deliver the article B (f in FIG. 1).

Here, the distribution label A is a two-dimensional bar code generated from information obtained by using the user's public key to encrypt a shop ID (the public key certificate for the shop, an ID obtained from this certificate, and so forth), the article information, and a user ID (the user's public key certificate, an ID obtained from this certificate, and so forth) or an electronic signature generated by the user. Alternatively, the distribution label A is an IC tag that stores the above information, and so forth. Further, the above described transmission of the public keys or public key certificates can be replaced with the transmission of the IDs obtained from these public keys or public key certificates.

The user's mobile terminal 4 receives the authentication information transmitted by the PKI 1. When the distributor 3 delivers the article B to the user (g in FIG. 1; step S8 in FIG. 5), the user's mobile terminal 4 uses the distribution label reading function 44 to read the information from the distribution label A attached to the article B (step S9 in FIG. 5).

In this case, if the distribution label A is a two-dimensional bar code, the distribution label reading function 44 comprises a scanner function for reading this two-dimensional bar code or an interface used to receive information obtained by reading the two-dimensional bar code using a scanner function of a terminal used by the distributor. On the other hand, if the distribution label A is an IC tag, the distribution label reading function 44 comprises a function of reading information from this IC tag.

The user's mobile terminal 4 uses the decrypting function 45 to decrypt the information read from the distribution label A by the distribution label reading function 44, on the basis of the user's secret key (step S10 in FIG. 5). The user's mobile terminal 4 then uses the authenticating function 46 to carry out authentication on the basis of the information from the distribution label A and the authentication information from the PKI 1 (h in FIG. 1; step S11 in FIG. 5).

Here, the authenticating function 46 compares the information from the distribution label A with the authentication information from the PKI 1 to verify and check the article information, order ID, and shop's public key certificate obtained from the distribution label A and authentication information. The authenticating function 46 also displays the results of the verification and check on a screen (not shown).

Thus, the user can electronically check where the article B has been originated, who has ordered it, what it is, and other information, on the basis of the electronic signature containing the certificate for the public key for electronic certification.

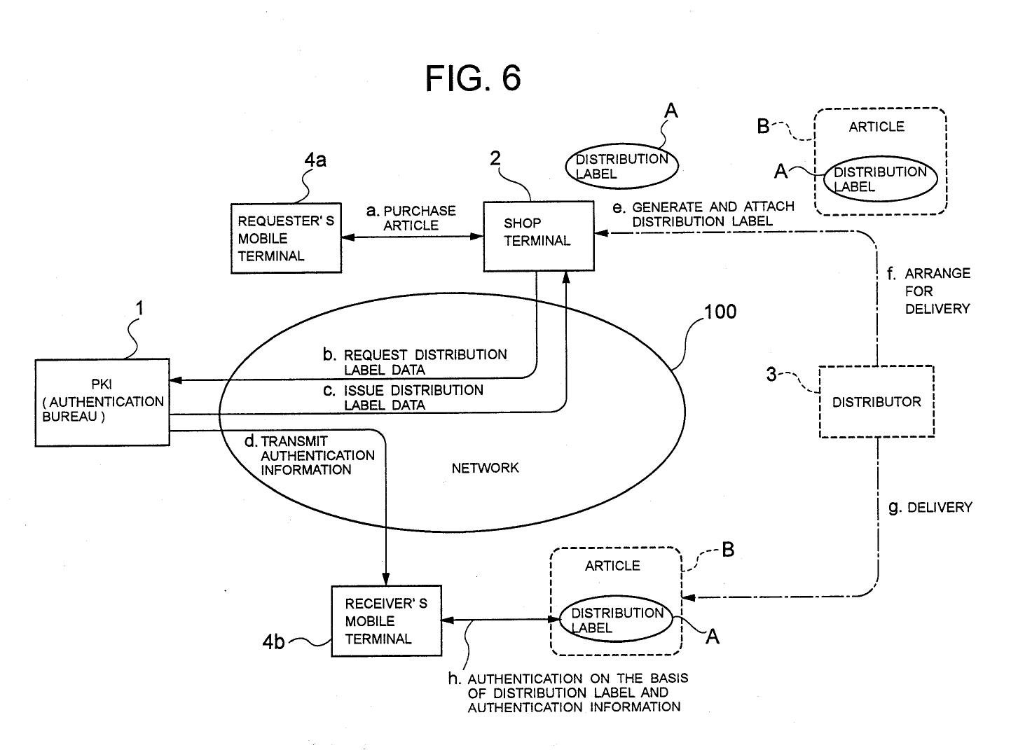

FIG. 6 is a block diagram showing a configuration of a logistic PKI service system according to a second embodiment of the present invention. In FIG. 6, the logistic PKI service system according to the second embodiment of the present invention represents a service model for a local environment in which an article is purchased at a shop and then delivered from the shop.

The logistic PKI service system according to the second embodiment of the present invention operates similarly to that according to the first embodiment of the present invention, shown in FIG. 1, except that an article is purchased at the shop and then delivered from the shop. In this case, this logistic PKI service system is similar to that according to the first embodiment of the present invention except in that a requester and a receiver each use the user's mobile terminal 4 described above to request the purchase of the article B and receive it, respectively, without using the network 100.

In general, in the local environment for the mobile EC, a part of a transaction is executed at an actual shop. For example, the local environment is the purchase of an article at a convenience store that uses the mobile EC for settlement, and so forth.

With the logistic PKI service, if an article is purchased at the shop and then delivered from the shop, when the article B purchased at the shop is delivered, information issued by the PKI 1 and relating to the article B is attached to the article B as a distribution label A. When the receiver receives the article B from the distributor 3, he or she can use the mobile terminal 4 to read, from the distribution label A, the electronic signature containing the certificate for the public key which electronically indicates where the article B has been originated, who has ordered it, what it is, and so forth. The receiver can thus electronically check these pieces of information.

The above described service model is of a so-called B2C type based on the assumption that an article is purchased at the shop. In this model, the requester is a purchaser of the article, the receiver is a receiver of the article, the sender of the article is a shop, and the distributor is a home delivery service company. A secure distribution system can be provided by utilizing the logistic PKI service under the mobile terminals 4 of the requester and receiver, the PKI (authentication bureau) 1, and the distributor 3. Substantially the same model is applicable to home delivery service or general mail service (registered mail and so forth), P2P (Peer to Peer).

The configuration of the mobile terminals 4 (the requester's mobile terminal 4a and the receiver's mobile terminal 4b) used in the present embodiment is similar to that of the mobile terminal 4 according to the first embodiment of the present invention, shown in FIG. 2. The requester's mobile terminal 4a uses the delivery requesting function 42 to communicate with a POS (Point Of Sales; not shown) in the shop to request the delivery of the article B purchased at the shop.

In the present embodiment, the POS in the shop corresponds to the shop terminal 2. The delivery requesting function 42 communicates with the communicating with mobile terminal function 25 of the shop terminal 2. The possible communication between the delivery requesting function 42 and the communicating with mobile terminal function 25 is based on non-contact ICs (Integrated Circuits), IrDA (Infrared Data Association), Bluetooth (R), and so forth. In some cases, information required to generate a distribution label A may be transmitted.

On the other hand, in the receiver's mobile terminal 4b, the distribution label reading function 44 reads the information from the distribution label A. The decrypting function 45 uses the receiver's secret key to decrypt the information read from the distribution label A decrypted by the decrypting function 45. The authenticating function 46 carries out authentication on the basis of the decrypted information of the distribution label A by the decrypting function 45. Other functions of the requester's mobile terminal 4a and the receiver's mobile terminal 4b include a telephone function of a cellular phone and a data processing function of a PDA as in the case with the mobile terminal 4 in the first embodiment of the present invention, shown in FIG. 2.

The configuration of the PKI 1 used in the present embodiment is similar to that of the PKI 1 in the first embodiment of the present invention, shown in FIG. 3. This PKI 1 requires the user certificate issuing function 12 to issue as many user certificates as the mobile terminals 4 (+α). Further, the distribution label data issuing function 13 issues distribution label data for each distribution transaction.

The configuration of the distribution label processing apparatus of the shop terminal 2 used in the present embodiment is similar to that of the shop terminal 2 in the first embodiment of the present invention, shown in FIG. 4. Although distribution label data is issued by the above described PKI 1, the distribution label A is attached to the actual article B by the distribution label processing apparatus of the shop or distributor. Accordingly, a device is required for this purpose.

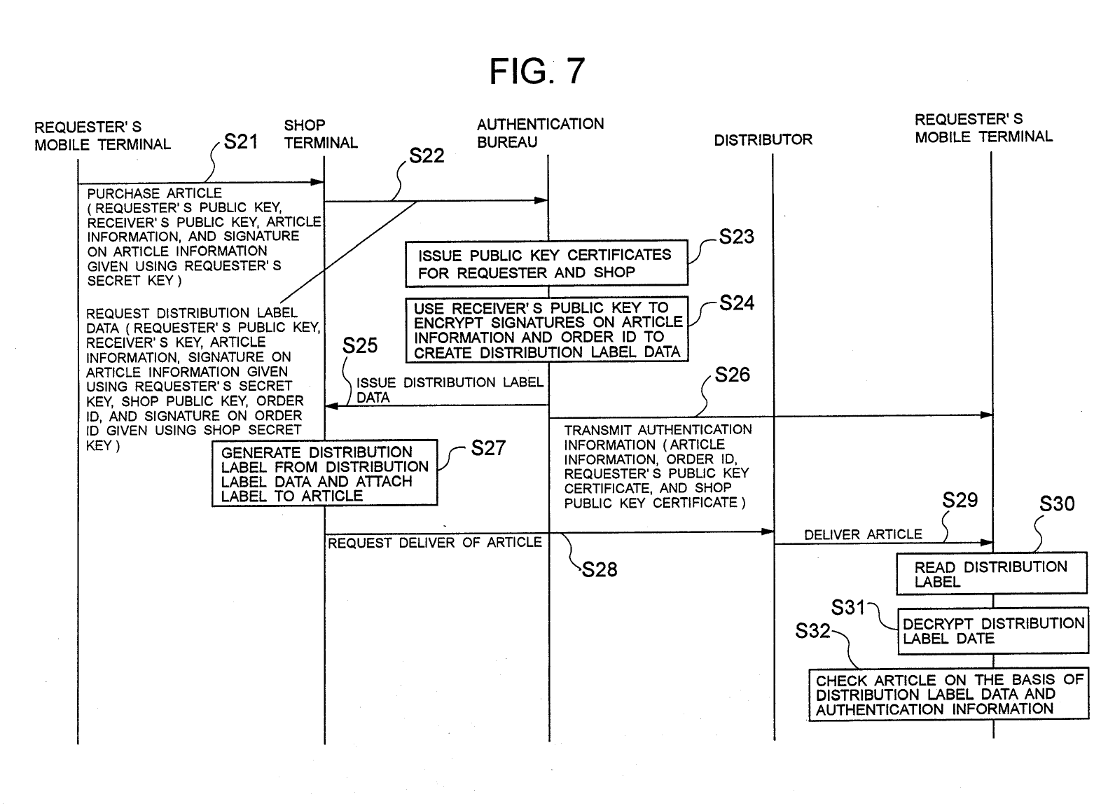

FIG. 7 is a sequence chart showing operations performed by the logistic PKI service system according to the second embodiment of the present invention. With reference to FIGS. 2 to 4, 6, and 7, description will be given of the operations of the logistic PKI service system according to the second embodiment of the present invention. In the description below, the requester, the receiver, and the shop each have a secret key. The PKI 1 issues, as electronic signatures, public key certificates that certify public keys for these secret keys.

First, the requester uses the delivery requesting function 42 of the mobile terminal 4a to request the delivery of the article B via the communicating with mobile terminal function 25 of the shop terminal 2 (a in FIG. 6; step S21 in FIG. 7). The shop terminal 2 uses the distribution label data processing function 21 to request the PKI 1 to issue distribution label data on the basis of information (the requester's public key, the receiver's public key, article information, and a signature on the article information given using the requester's secret key) input from the user's mobile terminal 4 (b in FIG. 6; step S22 in FIG. 7).

In response to the request for issuance of distribution label data, the PKI 1 uses the shop certificate issuing function 11 and the user certificate issuing function 12 to issue public key certificates for the requester and the shop, respectively, on the basis of the information (the requester's public key, the receiver's public key, the article information, the signature on the article information given using the requester's secret key, the public key of the shop, an order ID, and a signature on the order ID given using the secret key of the shop) input from the shop terminal 2 (step S23 in FIG. 7). The PKI 1 then uses the distribution label data issuing function 13 to encrypt the signatures on the article information and order ID on the basis of the receiver's public key. Thus, distribution label data is created (step S24 in FIG. 7).

The PKI 1 transmits the created distribution label data to the shop terminal 2 (c in FIG. 6; step S25 in FIG. 7). The PKI 1 then uses the encrypting function 14 to encrypt the above information (the article information, the order ID, the requester's public key certificate, and the public key certificate for the shop) on the basis of the receiver's public key to obtain authentication information. The PKI 1 then transmits the authentication information to the receiver's mobile terminal 4b using an electronic mail and so forth (d in FIG. 6; step S26 in FIG. 7).

Upon receiving the distribution label data issued by the PKI 1, the shop terminal 2 generates a distribution label A on the basis of the distribution label data from the PKI 1. The shop terminal 2 then attaches the distribution label A to the article B (e in FIG. 6; step S27 in FIG. 7) and then requests the distributor 3 to deliver the article B (f in FIG. 6; step S28 in FIG. 7).

Here, the distribution label A is a two-dimensional bar code generated from information obtained by using the receiver's public key to encrypt a shop ID (the public key certificate for the shop, an ID obtained from this certificate, and so forth), the article information, and a requester ID (the requester's public key certificate, an ID obtained from this certificate, and so forth) or an electronic signature generated by the requester. Alternatively, the distribution label A is an IC tag that stores the above information, and so forth. Further, the above described transmission of the public keys or public key certificates can be replaced with the transmission of the IDs obtained from these public keys or public key certificates.

The receiver's mobile terminal 4b receives the authentication information transmitted by the PKI 1. When the distributor 3 delivers the article B to the receiver (g in FIG. 6; step S29 in FIG. 7), the receiver's mobile terminal 4b uses the distribution label reading function 44 to read the information from the distribution label A attached to the article B (step S30 in FIG. 7).

In this case, if the distribution label A is a two-dimensional bar code, the distribution label reading function 44 comprises a scanner function for reading this two-dimensional bar code or an interface used to receive information obtained by reading the two-dimensional bar code using a scanner function of a terminal used by the distributor. On the other hand, if the distribution label A is an IC tag, the distribution label reading function 44 comprises a function of reading information from this IC tag.

The receiver's mobile terminal 4b uses the decrypting function 45 to decrypt the information read from the distribution label A by the distribution label reading function 44, on the basis of the receiver's secret key (step S31 in FIG. 7). The receiver's mobile terminal 4b then uses the authenticating function 46 to carry out authentication on the basis of the information from the distribution label A and the authentication information from the PKI 1 (h in FIG. 6; step S32 in FIG. 7).

Here, the authenticating function 46 compares the information from the distribution label A with the authentication information from the PKI 1 to verify and check the article information, order ID, requester's public key certificate, and shop's public key certificate obtained from the distribution label A and authentication information. The authenticating function 46 also displays the results of the verification and check on a screen (not shown).

Thus, the receiver can electronically check where the article B has been originated, who has ordered it, what it is, and other information, on the basis of the electronic signature containing the certificate for the public key for electronic certification.

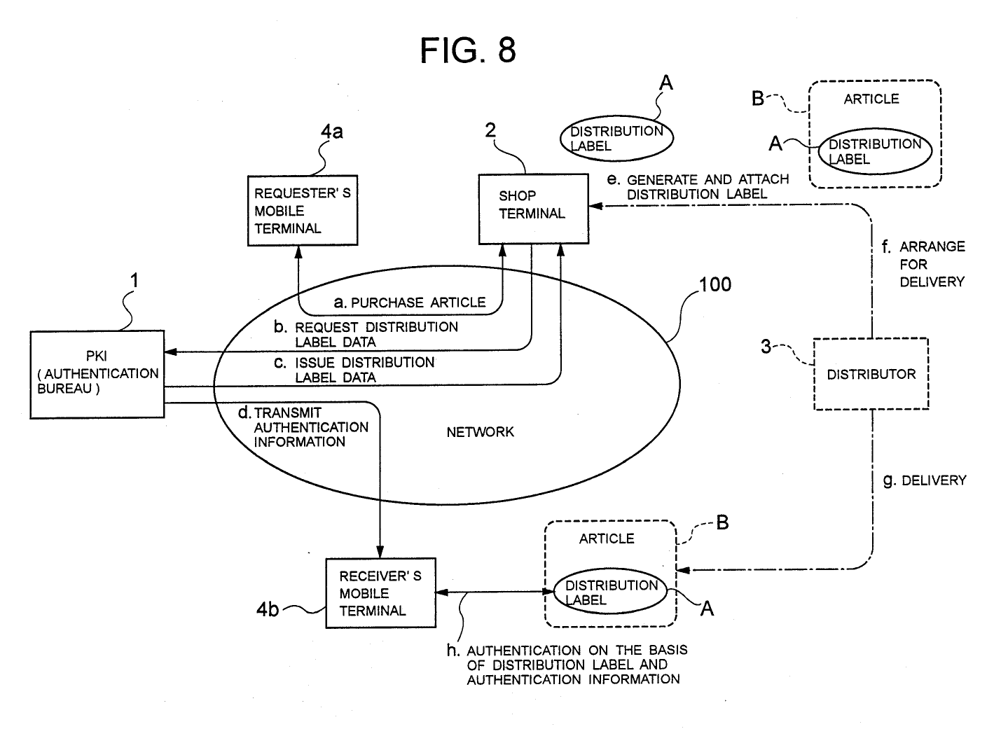

FIG. 8 is a block diagram showing a configuration of a logistic PKI service system according to a third embodiment of the present invention. In FIG. 8, the logistic PKI service system according to the third embodiment of the present invention represents a service model for a local environment in which an article is purchased at a shop and then delivered from the shop.

The logistic PKI service system according to the third embodiment of the present invention operates similarly to that according to the second embodiment of the present invention, shown in FIG. 6, except that an article is purchased at the shop via the network 100 at the mobile terminal 4a.

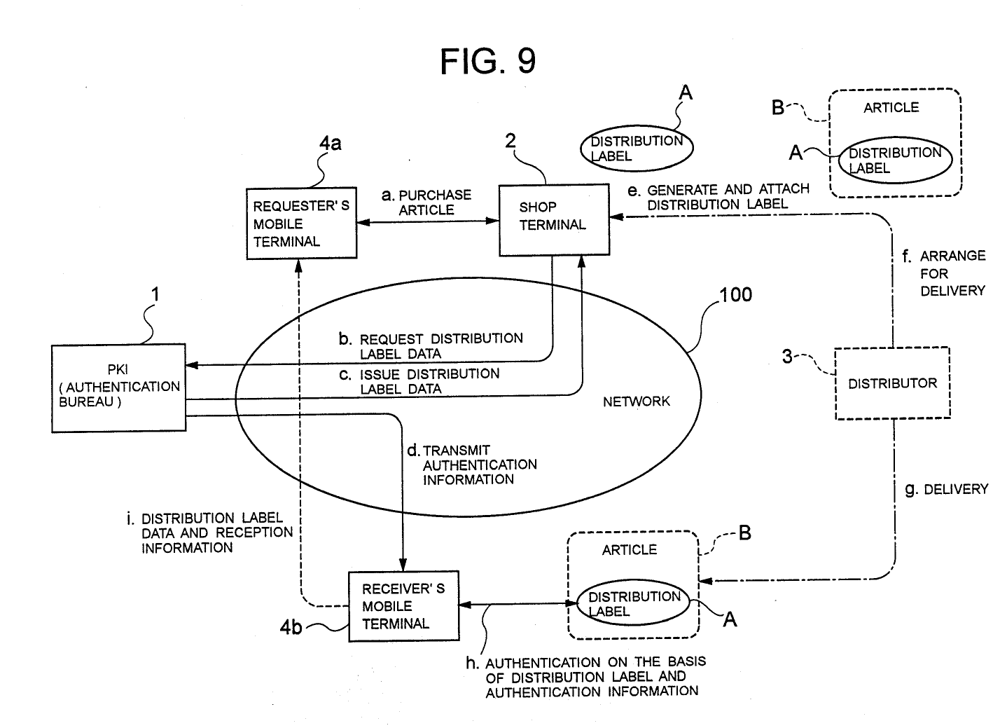

FIG. 9 is a block diagram showing a configuration of a logistic PKI service system according to a fourth embodiment of the present invention. In FIG. 9, the logistic PKI service system according to the fourth embodiment of the present invention represents a service model for a local environment in which an article is purchased at a shop and then delivered from the shop.

The logistic PKI service system according to the fourth embodiment of the present invention operates similarly to that according to the second embodiment of the present invention, shown in FIG. 6, except that the receiver notifies the requester, via the network 100, of contents checked electronically by himself or herself.

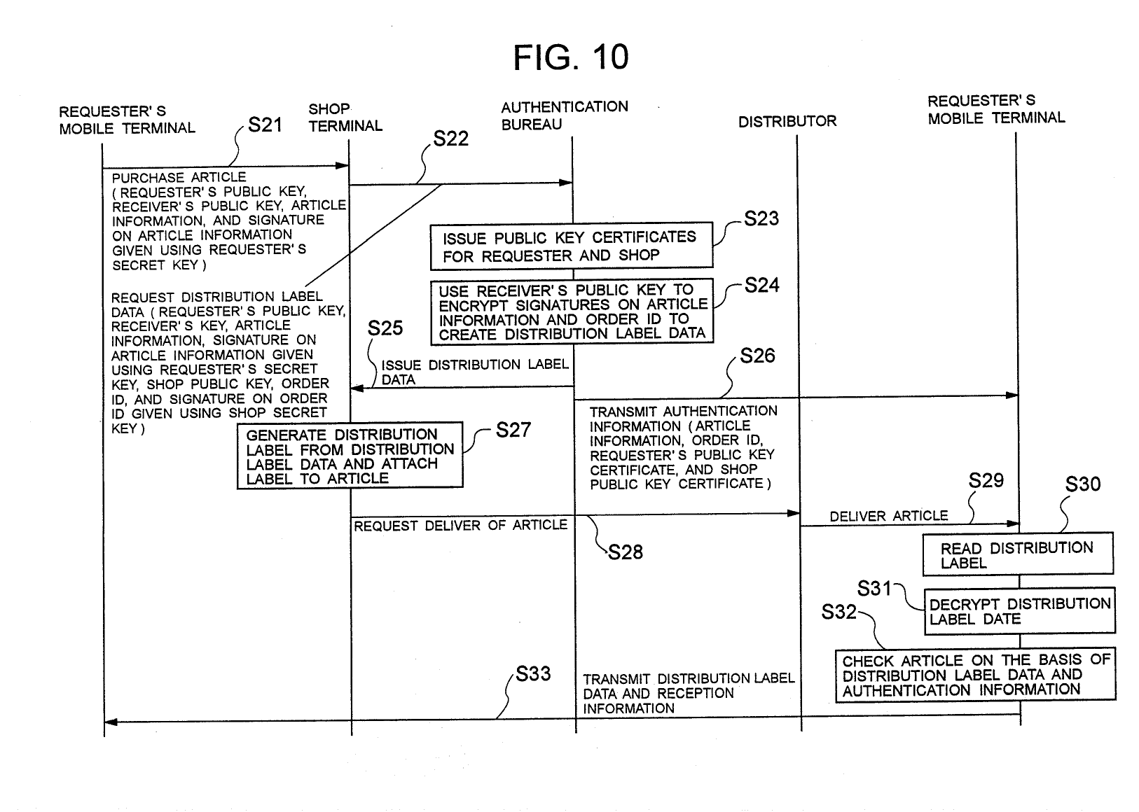

FIG. 10 is a sequence chart showing operations performed by the logistic PKI service system according to the fourth embodiment of the present invention. In FIG. 10, steps S21 to S32 are similar to the corresponding operations of the logistic PKI service system according to the second embodiment of the present invention, shown in FIG. 7. Accordingly, their description is omitted.

The receiver's mobile terminal 4b notifies the requester's mobile terminal 4a, via the network 100, of the results of authentication based on the information from the distribution label A and the authentication information from the PKI 1 (i in FIG. 9; step S33 in FIG. 10). In this case, the receiver's mobile terminal 4b uses an electronic mail and so forth to notify the requester's mobile terminal 4a of the information from the distribution label A decrypted by the decrypting function 45 as well as reception information on the article B.

Thus, the requester can electronically confirm that the requester has received the article B the delivery of which has been requested by the requester. In this regard, it is also possible to check, on the network 100, how the distributor 3 is delivering the article B, using the distribution label A of the above described first to fourth embodiments of the present invention.

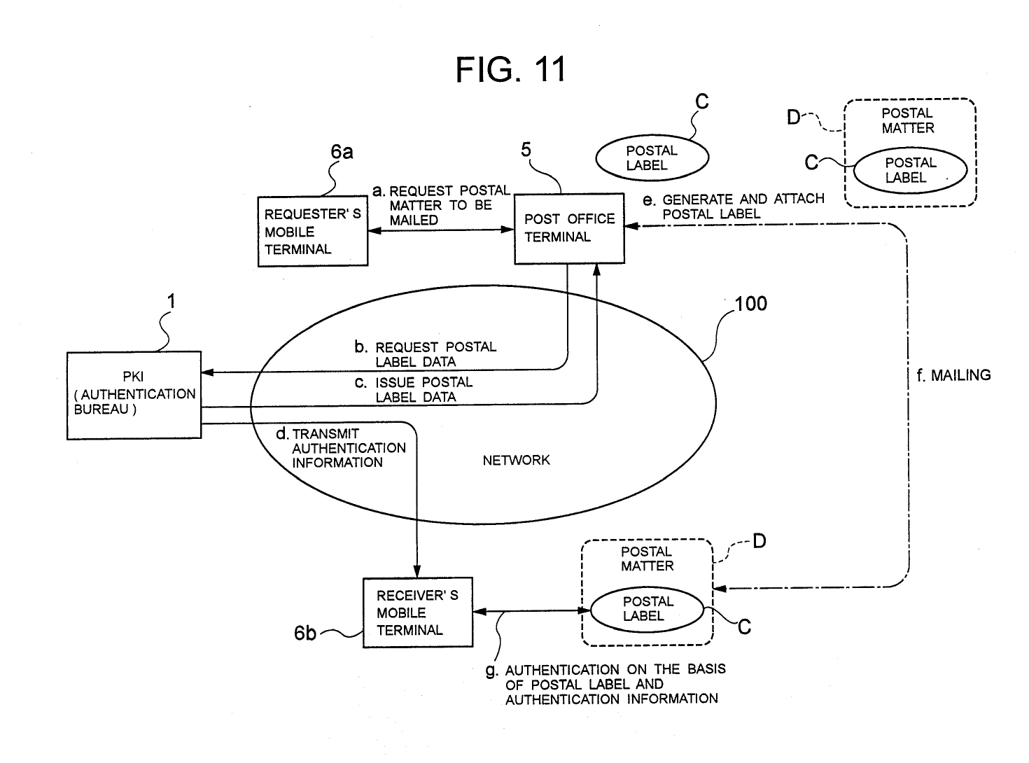

FIG. 11 is a block diagram showing a configuration of a logistic PKI service system according to a fifth embodiment of the present invention. In FIG. 11, the logistic PKI service system according to the fifth embodiment of the present invention represents a service model in which the present invention is applied to mail service (registered mail and so forth). This logistic PKI service system is composed of the PKI (authentication bureau) 1, a post office terminal 5, the requester's mobile terminal 6a, and the receiver's mobile terminal 6b.

The above described first and second embodiments of the present invention both correspond to B2C in that a user purchases an article at a shop to give rise to the needs for distribution. However, the application of the present invention to existing mail service (registered mail and so forth) according to the present embodiment corresponds to P2P in that, in spite of the involvement of a mail service as distribution, an article itself is basically possessed by a sender and a receiver.

With the logistic PKI service, when postal matter D is mailed, i.e. when the postal matter D requested from the post office is mailed, information issued by the PKI 1 and relating to the postal matter D is attached to the postal matter D as postal label C. Upon receiving the postal matter D from a mail service provider, the receiver can used the mobile terminal 6b to read, from the postal label C, information indicating where the postal matter D has been originated, who has requested to mail it, and other information. Accordingly, the receiver can electronically check these pieces of information.

The above described service model is of a so-called P2P type based on the assumption that the postal matter D is mailed via the post office. In this model, the requester is a person who requests the postal matter to be mailed, the receiver is the receiver of the postal matter, and a mailer of the postal matter is a model of a mail service provider. A secure mail system can be provided utilizing the logistic PKI service under the requester's mobile terminal 6a, the receiver's mobile terminal 6b, the PKI 1, and the mail service provider. Substantially the same service model is applicable to home delivery service requested by individuals.

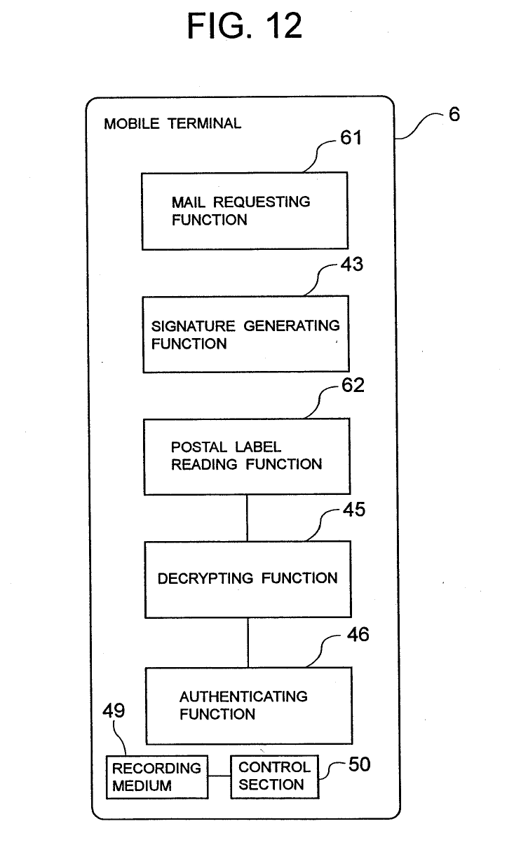

FIG. 12 is a block diagram showing a configuration of the mobile terminal 6a or 6b in FIG. 11. In FIG. 7, the mobile terminal 6 includes a mail requesting function 61 of requesting postal matter to be mailed, a signature generating function 43 of generating an electronic signature, a mail label reading function 62 of reading a postal label C, a decrypting function 45 of decrypting information from the postal label C, an authenticating function 46 of carrying out authentication on the basis of the decrypted information from the postal label C, a recording medium 49 in which a program for the PKI service is recorded, and a control section 50 that controls these functions according to this program. The requester's mobile terminal 6a and the receiver's mobile terminal 6b each have a configuration similar to that of the above terminal 6 and perform operations similar to those of it.

Other possible functions of the requester's mobile terminal 6a and the receiver's mobile terminal 6b, i.e. a telephone function of a cellular phone, a data processing function of a PDA, and the like, are well known. Accordingly, description of their configurations and operations is omitted.

Further, the mail requesting function 61 communicates with a POS (not shown) in the post office to request it to mail the postal matter D. The mail requesting function 61 may be composed of non-contact ICs, IrDA, Bluetooth (R), and so forth. In some cases, information required to generate a postal label C may be transmitted.

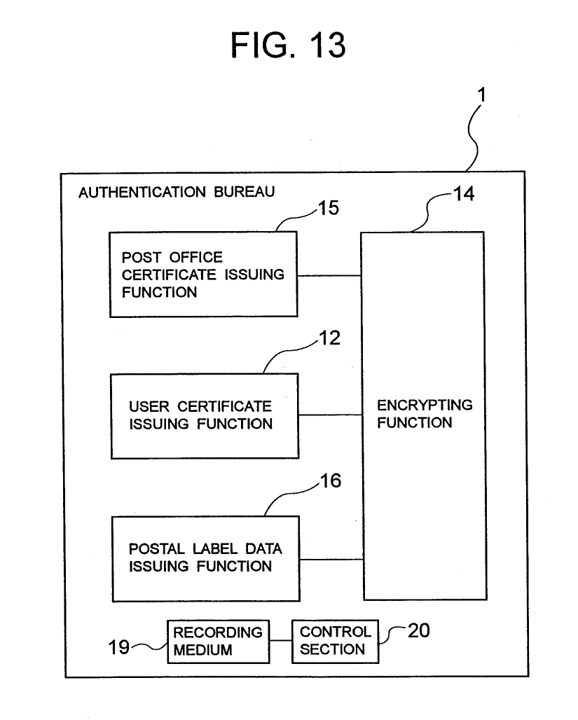

FIG. 13 is a block diagram showing a configuration of the PKI 1 in FIG. 11. In FIG. 13, the PKI 1 includes a post office certificate issuing function 15 of issuing an electronic signature containing a certificate for a public key of the post office and so forth, a user certificate issuing function 12 of issuing electronic signatures containing certificates for the requester's and receiver's public keys and so forth, a postal label data issuing function 16 of issuing postal label data on the basis of the electronic signatures issued by the post office certificate issuing function 15 and user certificate issuing function 12 as well as postal matter information from a post office shop terminal 5, an encrypting function 14 of encrypting the electronic signatures issued by the post office certificate issuing function 15 and user certificate issuing function 12 as well as the postal label data issued by the postal label data issuing function 16, a recording medium 19 in which a program for the PKI service is recorded, and a control section 20 that controls these functions according to this program.

This PKI 1 requires the user certificate issuing function 12 to issue as many user certificates as the above mobile terminals 6 (+α). Further, the postal label data issuing function 16 issues postal label data for each distribution transaction.

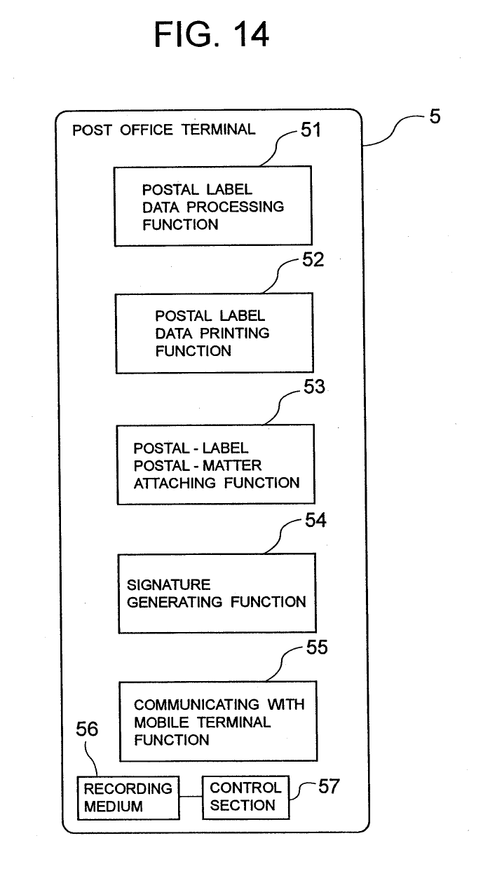

FIG. 14 is a block diagram showing a configuration of the post office terminal 5 in FIG. 11. In FIG. 14, the post office terminal 5 includes a postal label processing apparatus composed of a postal label data processing function 51 of requesting the PKI 1 to issue postal label data and processing postal label data from the PKI 1, a postal label data printing function 52 of printing the postal label data processed by the postal label data processing function 51, and a postal-label postal-matter attaching function 53 of attaching the postal label C printed by the postal label data printing function 52, to the postal matter D; a signature generating function 54 of generating an electronic signature; a mobile-terminal communicating function 55 of communicating with the requester's terminal 6a; a recording medium 56 in which a program for the PKI service is recorded; and a control section 57 that controls these functions according to this program. Although postal label data is issued by the above described PKI 1, the postal label C is attached to the actual postal matter D by the postal label processing apparatus of the post office.

The postal label data processing function 51 processes the postal label data sent from the PK11 as the digital data through the network 100, and the postal label data printing function 52 prints the postal label data processed by the postal label data processing function 51, as the postal label C. The postal-label postal-matter attaching function 53 attaches the postal label C printed by the postal label data printing function 52 on the postal matter D.

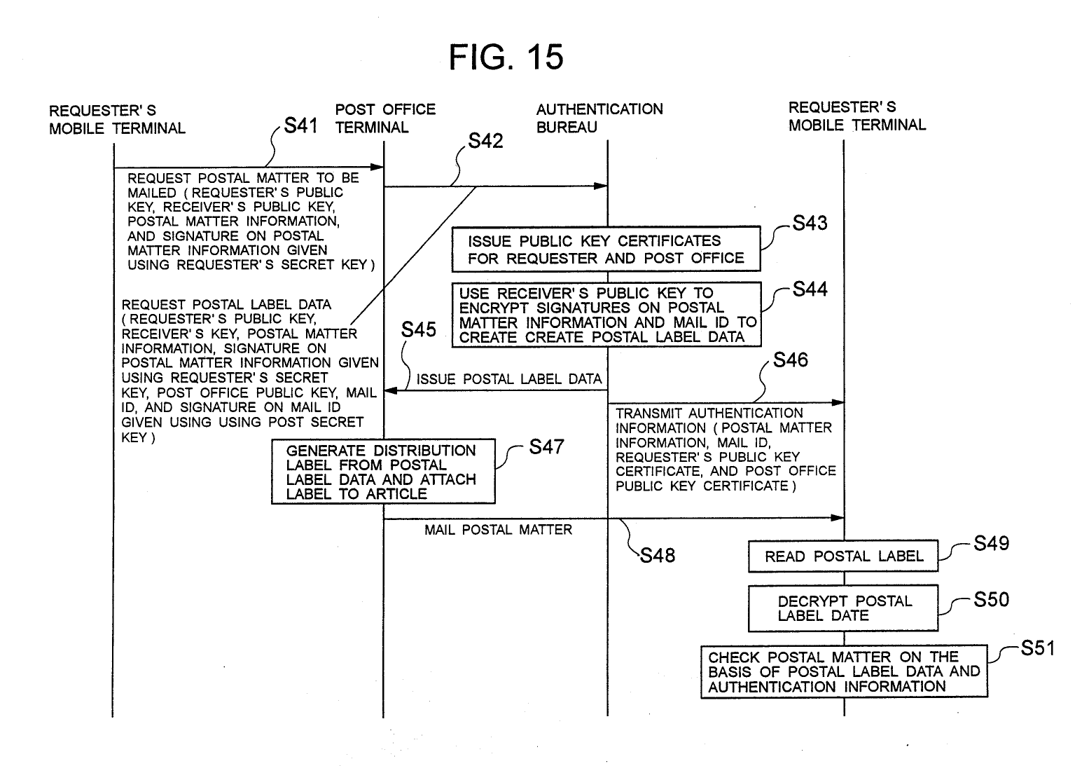

FIG. 15 is a sequence chart showing operations performed by a logistic PKI service system according to a fifth embodiment of the present invention. With reference to FIGS. 11 to 15, description will be given of the operations of the logistic PKI service system according to the fifth embodiment of the present invention. In the description below, it is assumed that the requester, the receiver, and the post office each have a secret key and that the PKI 1 issues, as electronic signatures, public key certificates that authenticate public keys for these secret keys.

First, the requester requests the postal matter D to be mailed by using the mobile terminal 6a (a in FIG. 11; step S41 in FIG. 15). The post office terminal 5 uses the postal label data processing function 51 to request the PKI 1 to issue postal label data on the basis of information (the requester's public key, the receiver's public key, postal matter information, and a signature on the postal matter information given using the requester's secret key) input from the requester's mobile terminal 6a (b in FIG. 11; step S42 in FIG. 15).

In response to the request for issuance of distribution label data, the PKI 1 uses the post office certificate issuing function 15 and the user certificate issuing function 12 to issue public key certificates for the requester and the post office, respectively, on the basis of the information (the requester's public key, the receiver's public key, the postal matter information, the signature on the postal matter information given using the requester's secret key, the public key of the post office, a mail ID, and a signature on the mail ID given using the secret key of the post office) input from the post office terminal 5 (step S43 in FIG. 15). The PKI 1 then uses the postal label data issuing function 16 to encrypt the signatures on the postal matter information and mail ID on the basis of the receiver's public key. Thus, postal label data is created (step S44 in FIG. 15).

The PKI 1 transmits the created postal label data to the post office terminal 5 (c in FIG. 11; step S45 in FIG. 15). The PKI 1 then uses the encrypting function 14 to encrypt the above information (the postal matter information, the mail ID, the requester's public key certificate, and the public key certificate for the post office) on the basis of the receiver's public key. The PKI 1 then transmits the encrypted information to the receiver's mobile terminal 6b using an electronic mail and so forth (d in FIG. 11; step S46 in FIG. 15).

Upon receiving the postal label data issued by the PKI 1, the post office terminal 5 generates a postal label C on the basis of the postal label data from the PKI 1. The post office terminal 5 then attaches the postal label C to the postal matter D (e in FIG. 11; step S47 in FIG. 15) and then mails the postal matter D (f in FIG. 11; step S48 in FIG. 15).

Here, the postal label C is a two-dimensional bar code generated from information obtained by using the receiver's public key to encrypt a post office ID (the public key certificate for the post office, an ID obtained from this certificate, and so forth), the postal matter information, and a requester ID (the requester's public key certificate, an ID obtained from this certificate, and so forth) or an electronic signature generated by the requester. Alternatively, the postal label C is an IC tag that stores the above information, and so forth. Further, the above described transmission of the public keys or public key certificates can be replaced with the transmission of the IDs obtained from these public keys or public key certificates.

The receiver's mobile terminal 6b receives the authentication information transmitted by the PKI 1. When the post office mails the postal matter D to the receiver, the receiver's mobile terminal 6b uses the postal label reading function 62 to read the information from the postal label C attached to the postal matter D (step S49 in FIG. 15).

In this case, if the postal label C is a two-dimensional bar code, the postal label reading function 62 comprises a scanner function for reading this two-dimensional bar code or an interface used to receive information obtained by reading the two-dimensional bar code using a scanner function of a terminal used by a post officer. On the other hand, if the postal label C is an IC tag, the postal label reading function 62 comprises a function of reading information from this IC tag.

The receiver's mobile terminal 6b uses the decrypting function 45 to decrypt the information read from the postal label C by the postal label reading function 62, on the basis of the receiver's secret key (step S50 in FIG. 15). The receiver's mobile terminal 6b then uses the authenticating function 46 to carry out authentication on the basis of the information from the postal label C and the authentication information from the PKI 1 (h in FIG. 11; step S51 in FIG. 15).

Here, the authenticating function 46 compares the information from the postal label C with the authentication information from the PKI 1 to verify and check the postal matter information, mail ID, requester's public key certificate, and post office's public key certificate obtained from the postal label C and authentication information. The authenticating function 46 also displays the results of the verification and check on a screen (not shown).

Thus, the receiver can electronically check who has sent the postal matter D, what it is, and other information, on the basis of the electronic signature containing the certificate for the public key for electronic certification.

As described above, according to the present invention, when a delivered article is requested to be delivered, the authentication bureau issues label data indicating information on the delivered article and authentication information on the article. Then, the terminal apparatus generates a label on the basis of the label data from the authentication bureau and attaches it to the delivered article. Then, the mobile terminal carries out authentication on the basis of information read from the label attached to the delivered article that has been delivered as well as the authentication information from the authentication bureau. This improves reliability and security in the distribution portion of the system.

What is claimed is:

1. A logistic PKI service system comprising:
a terminal apparatus which requests an authentication bureau to provide label data indicative of information on a delivered article before delivery and generates a label to be attached to said delivered article on the basis of said transmitted label data;
the authentication bureau which responds to the request from said terminal apparatus to issue said label data and authentication information on said delivered article; and
a mobile terminal which carries out authentication on the basis of information read from said label attached to said delivered article that has been delivered and said authentication information from said authentication bureau,
wherein the requester of said delivered article and the receiver of said delivered article are the same.

2. A logistic PKI service method comprising the steps of:
in a terminal apparatus, requesting an authentication bureau to provide label data indicative of information on a delivered article before delivery and generates a label to be attached to said delivered article on the basis of said label data transmitted in response to the request;
in said authentication bureau, responding to the request from said terminal apparatus to issue said label data and authentication information on said delivered article; and
in a mobile terminal, carrying out authentication on the basis of information read from said label attached to said delivered article that has been delivered and said authentication information from said authentication bureau,
wherein the requester of said delivered article and the receiver of said delivered article are the same.

3. A recording medium in which a program is recorded to execute the steps of:
in a terminal apparatus, requesting an authentication bureau to provide label data indicative of information on a delivered article before delivery and generates a label to be attached to said delivered article on the basis of said label data transmitted in response to the request;
in said authentication bureau, responding to the request from said terminal apparatus to issue said label data and authentication information on said delivered article; and
in a mobile terminal, carrying out authentication on the basis of information read from said label attached to said delivered article that has been delivered and said authentication information from said authentication bureau,
wherein the requester of said delivered article and the receiver of said delivered article are the same.
